(19) United States
(12) Patent Application Publication
(10) Pub. No.: US 2004/0066398 A1
(43) Pub. Date: Apr. 8, 2004

(54) System and method for removing, trimming and bookmarking images of an ultrasound image sequence

(75) Inventors: Damien Dolimier, Bothell, WA (US); Danny M. Skyba, Bothell, WA (US); Edward A. Miller, Everett, WA (US); Rohit Garg, Seattle, WA (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V

(21) Appl. No.: 10/264,031

(22) Filed: Oct. 3, 2002

(51) Int. Cl. G09G 5/00

(52) U.S. Cl. 345/720; 345/767

(57) ABSTRACT

A system and method are provided for simplifying off-line quantification of ultrasound images by displaying a graphical user interface showing a real-time ultrasound image for enabling a user to freeze the real-time ultrasound image to display an image sequence capable of being modified, i.e., by removing and/or trimming images thereof, and played back by the user. The system and method of the present invention are further capable of simplifying off-line quantification of ultrasound images by accessing and displaying via the graphical user interface a tagging system having a corresponding identification tag for each ultrasound image of the image sequence for selecting and bookmarking at least one image of the image sequence for easily accessing the image in the future. The system and method of the present invention are embodied by software modules each having a series of programmable instructions capable of being executed by a processor for performing their respective functions.

### FIELD OF THE INVENTION

The present invention relates generally to ultrasound image quantification and more specifically to a system and method for removing, trimming and manipulating bookmarked images of an ultrasound image sequence, i.e., a CINELOOP™ image sequence.

### BACKGROUND OF THE INVENTION

Traditionally quantitative analysis of ultrasound image data has been performed on-line, i.e., on the ultrasound system itself. Because of the limitation of performing complex analyses within the clinical workflow, quantification has been limited to two-dimensional x-y data such as distance, area and length or the analysis of Doppler waveforms. This is due primarily, to limited computational speed of the acquisition/display system and patient workflow management. More recently, complex analysis and measurements have been developed for off-line workstations. Current developments in computational speed are allowing the user to access more complex quantitative analysis both on-line and off-line (e.g. at a PC workstation) in a timely manner. The clinical practice is moving away from just anatomical imaging, to imaging methods which provide functional assessment. This information may be quantitative in nature, which gives the clinician access to physiological data in the management of their patients. These users will require tools to assist them in analyzing this information in a time-efficient and reproducible manner.

Despite the increase in computational power to perform more complex analyses on ultrasound images, there is still the need for user interaction with the ultrasound image data. Ultrasound images are typically stored in movie form, called CINELOOP™ images. Since ultrasound is an inherently real-time imaging modality, image frame rates are typically in excess of 30 Hz (30 frames/second). Therefore, even a modest 10-second CINELOOP™ sequence contains over 300 image frames.

Accordingly, there exists a need to provide navigation and editing tools for manipulating large CINELOOP™ data sets. Software functions such as the ability to trim the length of the CINELOOP™ image, establish a new starting frame, establish a new ending frame, remove frames from the active image display, or jump to a specific image frame at which a specific event occurred are critical to data management. The final edited or “trimmed” CINELOOP™ sequence can be then inputted into a more complex quantification algorithm from which clinically relevant information can be derived.

### SUMMARY

An aspect of the present invention is to provide a system and method for removing, trimming and jumping to bookmarked images of an ultrasound image sequence, i.e., a CINELOOP™ image.

In a preferred embodiment of the present invention, a system and method are provided for simplifying off-line quantification of ultrasound images by displaying a graphical user interface showing a real-time ultrasound image for enabling a user to freeze the real-time ultrasound image to display an image sequence capable of being modified, i.e., by removing and/or trimming images thereof, and played back by the user.

The system and method of the present invention are further capable of simplifying off-line quantification of ultrasound images by accessing and displaying via the graphical user interface a tagging system having a corresponding identification tag for each tagged ultrasound image of the CINELOOP™ sequence for selecting at least one image of the CINELOOP™ sequence for easily accessing the image in the future.

The system and method of the present invention are embodied by software modules each having a series of programmable instructions capable of being executed by a processor for performing their respective functions. One software module includes a series of programmable instructions for enabling a user to remove and/or trim ultrasound images in a CINELOOP™ image for forming a modified image sequence capable of being played back. Another software module includes a series of programmable instructions for enabling a user to advance to bookmarked ultrasound images in a CINELOOP™ sequence, which may include the modified CINELOOP™ sequence, for easily accessing the bookmarked images in the future.

The software modules are preferably stored within a memory storage device, such as a computer hard drive, within a memory module, such as a RAM or ROM module, and/or on a computer readable medium, such as a CD-ROM, and are capable of being accessed for execution by the processor. The software modules are preferably incorporated within a software quantification tool for use in off-line image review, quantification and interpretation of ultrasound images and other related data.

### BRIEF DESCRIPTION OF THE FIGURES

Various embodiments of the invention will be described herein below with reference to the figures wherein:

FIG. 1 is a block diagram of the system according to the present invention;

FIG. 2 is a screen view of a graphical user interface capable of being displayed by the system of FIG. 1; and

FIGS. 3A and 3B are operational flow block diagrams illustrating methods of operation according to the present invention.

### DETAILED DESCRIPTION OF THE PREFERRED EMBODIMENTS

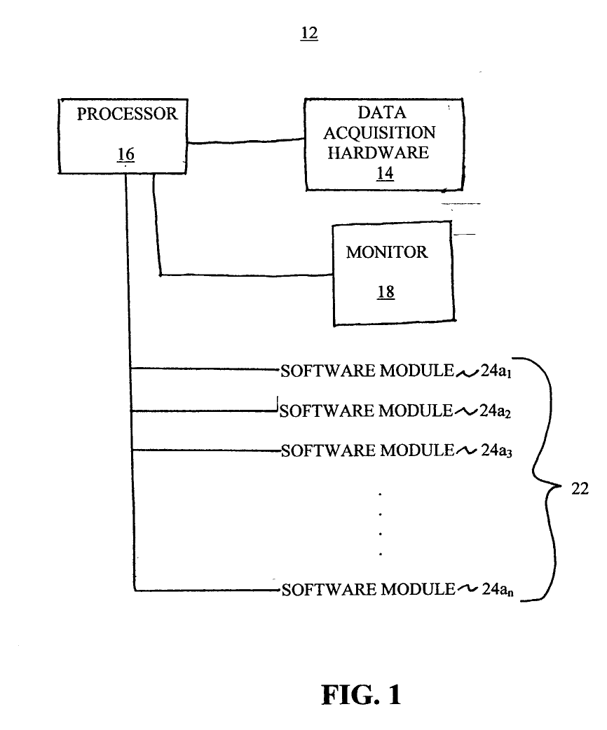

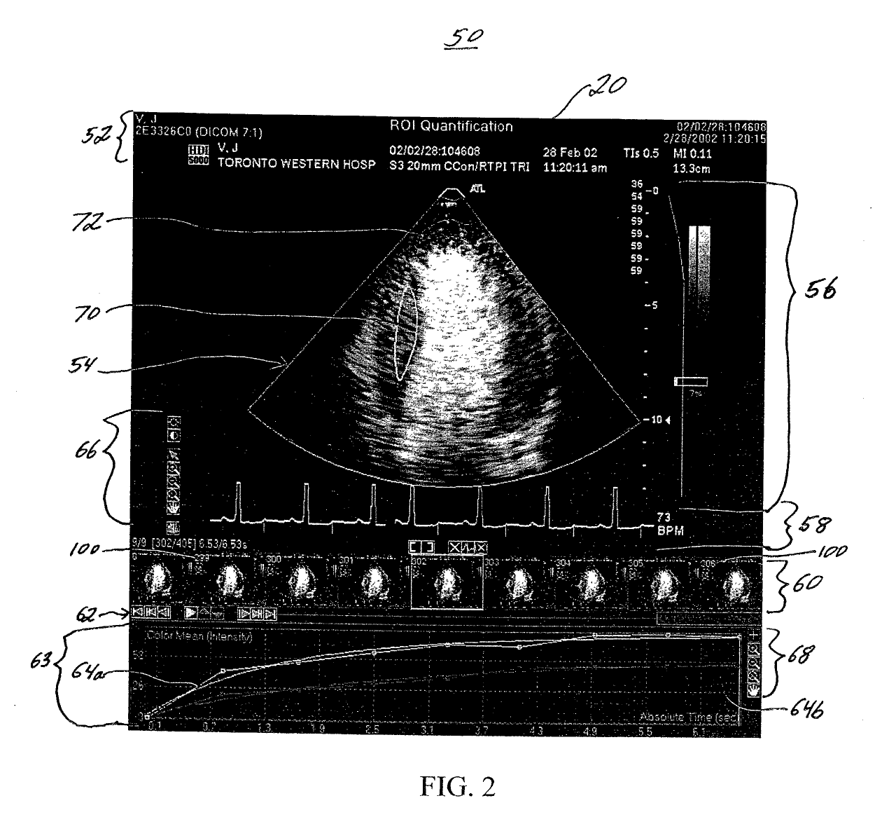

With reference to FIG. 1, there is shown a block diagram of a system according to the present invention and designated generally by reference numeral 10. The system 10 includes an ultrasound imaging system 12, such the SONOS™ 5500 digital echocardiography system or HDI 5000 system available from Philips Medical Systems, for acquiring and storing ultrasound images. The system 12 includes data acquisition hardware 14, such as an ultrasonic transducer and a keyboard, a processor 16 for processing the data, and a monitor 18 capable of displaying a graphical user interface 20 (see FIG. 2) of a software quantification tool. The graphical user interface 20 displays the acquired ultrasound images to a user, as well as other information.

The system 10 further includes operational software 22 capable of being executed by the processor 16 of the ultrasound imaging system 12 for performing the various functions of the imaging system 12, such as ultrasound image acquisition and harmonic image enhancement. The operational software 22 includes a plurality of software modules 24a₁-24aₐ or plug-ins for performing the various functions, including the functions and features of the present invention.

The plurality of software modules 24a₁-24aₙ are preferably stored within a memory storage device, such as a computer hard drive, within a memory module, such as a RAM or ROM module, and/or on a computer readable medium, such as a CD-ROM, and are capable of being accessed for execution by the processor 16. The plurality of software modules 24a₁-24aₙ are preferably incorporated within the software quantification tool for use in off-line image review, quantification and interpretation of ultrasound images and other related data.

With reference to FIG. 2, there is shown an exemplary screen 50 of the graphical user interface 20. The screen 50 includes time, patient and other data 52 on a top portion, a large frozen or paused playback image 54 of the myocardium, a vertical centimeter scale 56 along the right side of the image 54, a beats per minute (BPM) signal 58 below the image 54, thumbnail representations of the image frames 60, image review control soft buttons 62 (e.g., reverse, forward and play/pause, speed control, jump to first frame, frame step forward, jump to image of interest forward, jump to last frame, frame step backward, jump back to image of interest), a graph 63 displaying one-minus-exponential curves 64a, 64b below the thumbnail display 60, a first group of soft buttons 66 for at least adjusting the contrast of the image 54, selecting at least one region of interest (ROI) on the image 54, enlarging the image 54, moving the image 54, and zooming in and out with respect to the image 54, and a second group of soft buttons 68 for at least adjusting the position of the graph 63 displaying the curves 64a, 64b, and zooming in and out with respect to the graph 63 displaying the curves 64a, 64b.

In order to obtain the screen 50 of FIG. 2, the user freezes or pauses the large playback image 54 which is being played in real-time by clicking on the image 54 or by some other method. Upon freezing the large playback image 54, the frozen image frame and those preceding and following it are shown in a thumbnail sequence, i.e., by the thumbnail display 60, below the frozen image 54, as shown by FIG. 2. The border of the image which corresponds to the large playback image 54 is highlighted in the thumbnail display 60.

Each thumbnail corresponds to a respective image of the CINELOOP™ sequence 60 and is tagged by a respective tag of a tagging system, as described below, for removing, trimming, and jumping to bookmarked images. The tagging system primarily includes a plurality of tags 100 or reference numerals identifying each image of the CINELOOP™ sequence 60. The plurality of tags 100 are embodied within the system 12 as a data structure, such as a top-down stack or a sequence of objects connected or linked by pointers.

Each tag or reference numeral is positioned on the top left portion of each image. The images are tagged or numbered consecutively in the CINELOOP™ sequence 60. In the exemplary screen 50, the image of the CINELOOP™ sequence 60 identified by numeral 302 corresponds to the large playback image 54.

Two regions of interest 70, 72 are shown on the exemplary screen 50 as defined and selected by the user. The regions of interest 70, 72 are preferably selected by the user using an ROI software module which is preferably one of the plurality of software modules 24a₁-24aₙ. The one-minus-exponential curves 64a, 64b are fit by the quantification tool to the ROI data (white (bright) and black (dim)) corresponding to the two selected regions of interest 70, 72.

The system 10 of the present invention further includes a CINELOOP™ modification software module 24a₁ which includes a series of programmable instructions for enabling the user to remove and/or trim ultrasound images in the CINELOOP™ sequence 60 for forming a modified CINELOOP™ sequence capable of being played back by the ultrasound imaging system 12.

In order to form the modified CINELOOP™ sequence by removing images frames, the user selects the images of the CINELOOP™ sequence 60 which are not desired using a keyboard, a mouse, or other peripheral. If using a keyboard, the selects the desired image and and deleted the frame by pressing the Delete key which corresponds to the function displayed via a graphical user interface method generated by the software module.

If using a mouse, the user clicks on the image(s) he desires to remove, and then presses the “DELETE” key or left-clicks the mouse on the delete soft button. The user can then click on the delete soft button to remove the image(s) from the CINELOOP™ sequence 60. A plurality of images can be removed by highlighting the images desired to be removed and pressing the “DELETE” key or clicking on the delete soft button. Alternatively, the user can click a delete soft button 71 corresponding to the highlighted image, if the highlighted image is to be removed, or a delete soft button 73 corresponding to an image other than the highlighted image, if such an image is to be removed. The delete soft buttons 71, 73 set or reset the remove frame status of their corresponding frame.

Whether using the keyboard or the mouse, any number of frames can be tagged to be removed with the exception, in the preferred embodiment, of the first and last frame. The user can also select the frames to be removed using the image review control soft buttons 62. The graphical user interface 20 further includes a restore cut frame button 75 for restoring all previously cut frames to their default state without individually selecting each frame.

Upon removing an image from the CINELOOP™ sequence 60, the system 10 instantaneously reconfigures or modifies the CINELOOP™ sequence 60 to form the modified CINELOOP™ sequence 60 by removing the tag corresponding to the removed image from the tagging system. In particular, the CINELOOP™ modification software module 24a₁ identifies the tag in the tagging system corresponding to the image to be removed and removes that tag from the data structure to form a new data structure which represents the modified CINELOOP™ sequence.

In order to form the modified CINELOOP™ sequence by trimming images of the CINELOOP™ sequence 60, i.e., displaying at least one image, the user selects the image of the CINELOOP™ sequence 60 which is to be trimmed using the keyboard, the mouse, or other peripheral in a similar manner as described above for removing an image. Upon instructing the CINELOOP™ modification software module 24a₁ to trim an image, the CINELOOP™ modification software module 24a₁ tags the selected image frame as a cut or trimmed frame.

The original CINELOOP™ sequence 60 is modified so that the trimmed images are removed from the active display. It is provided that the user can then follow the above procedure to trim additional images.

In particular, during a trimming process the CINELOOP™ modification software module 24a₁ identifies the tag in the tagging system corresponding to the image to be trimmed and appends that tag with the appropriate user-defined trimming information. Accordingly, when the CINELOOP™ sequence is redisplayed the trimming information is accessed by the system 10 and the system 10 only displays only the untrimmed image frames.

The trim image CINELOOP™ software modification module 24a₁ does not affect the integrity of the original CINELOOP™ sequence 60.

To view any trimmed image, the user can select the thumbnail corresponding to the trimmed image using the mouse. The image would then be shown in its entirety and in its proper position in the CINELOOP™ sequence 60.

The user can click on the trimmed image using a mouse, click on the soft button control to restore the trimmed frame, to un-trim the image and display the image. Alternatively, the user may select the “Restore All Frames” soft button control to return the image display to its original configuration.

In order to access a bookmarked image, the user accesses the tagged images directly by activating a soft button control located below the image display. The bookmarked image is then instantaneously accessed and displayed by the graphical user interface 20.

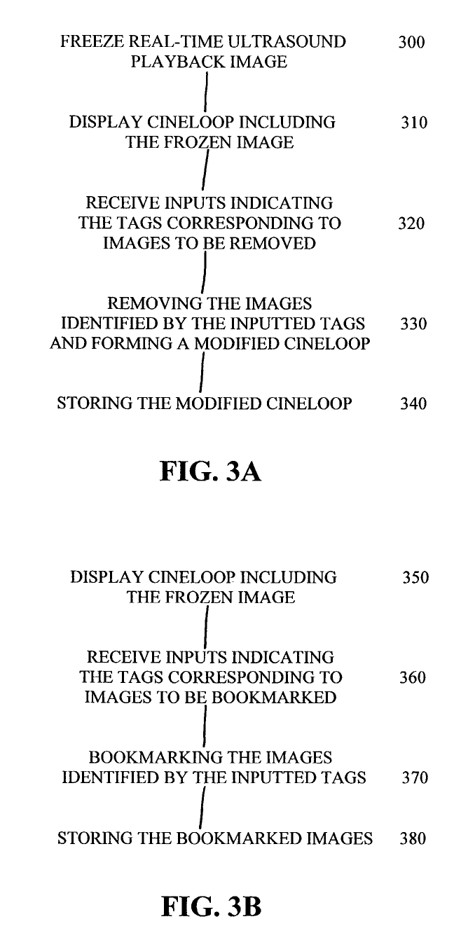

With reference to FIGS. 3A and 3B, there are shown operational flow block diagrams of the method of operation of the CINELOOP™ modification software module 24a₁ and the CINELOOP™ bookmarking software module 24a₂ for displaying the bookmarked ultrasound images of the CINELOOP™ sequence 60, respectively, according to the present invention.

The images described above which form the various CINELOOP™ sequences are preferably Real-time Perfusion Imaging (RTPI) images, since they are obtained using a RTPI technique. This technique combines low mechanical index imaging and Flash. The technique allows the visualization of contrast enhancement in the small vessels of the body in real-time (>10 Hz frame rates), down to the level of the microcirculation (i.e., capillary perfusion). Previous methods of contrast visualization required that images be collected at intermittent triggering intervals, often at intervals greater than 5 seconds between images (0.2 Hz), due to the destructive nature of the high mechanical index ultrasound power. Low mechanical index RTPI allows physicians to see structures in the body which are moving, such as the beating heart, in a cinematic fashion along with the contrast agent enhancement.

In RTPI, in order to clear the contrast enhancement, a brief burst of high mechanical index ultrasound, called Flash, is used. The Flash frames are automatically tagged by the ultrasound imaging device. The physician can then observe the dynamics of the contrast agent enhancement in the organ of interest. The ultrasound images are saved as a CINELOOP™sequence for replay, as well as for analysis with specialized image processing and quantification tools, such as the quantification tool described above having the CINELOOP™ modification software module 24a₁ and the CINELOOP™ bookmarking software module 24a₂ for removing, trimming and jumping to bookmarked ultrasound images.

Although the preferred embodiment is related to a system for the review, editing, analysis and storage of ultrasound images, the same tools described above for removing, trimming and bookmarking ultrasound images are relevant to any medical imaging modality that uses real-time data for quantification. Examples of such modalities are X-ray, Computed Tomography, Magnetic Resonance Imaging, and Digital Angiography.

What has been described herein is merely illustrative of the principles of the present invention. For example, the system and method described above and implemented as the best mode for operating the present invention are for illustration purposes only. Other arrangements and methods may be implemented by those skilled in the art without departing from the scope and spirit of this invention.

We claim:

1. A method for processing ultrasound images comprising the steps of:
displaying an image sequence on a display consisting of a plurality of ultrasound images;
identifying each image of the plurality of ultrasound images by a tag of a tagging system; and
receiving at least one input corresponding to at least one tag for one of removing at least one image from the plurality of ultrasound images identified by the at least one inputted tag and trimming at least a portion of the at least one image in the plurality of ultrasound images identified by the at least one inputted tag to form a modified image sequence.

2. The method according to claim 1, further comprising the step of receiving an input to freeze a real-time ultrasound image during playback prior to the displaying step, wherein the frozen image is highlighted in the displayed image sequence.

3. The method according to claim 1, further comprising the steps of:
playing back the modified image sequence;
storing the modified image sequence; and
displaying the modified image sequence.

4. The method according to claim 1, wherein the image sequence and the modified image sequence consist of a plurality of Real-time Perfusion Imaging (RTPI) ultrasound images.

5. The method according to claim 1, further comprising the step of bookmarking at least one image of the image sequence.

6. The method according to claim 5, wherein the bookmarking step comprises the step of receiving at least one input corresponding to at least one tag identifying the at least one image to be bookmarked.

7. The method according to claim 1, wherein the tagging system includes at least one data structure, and wherein the step of removing comprises the step of removing an object from the at least one data structure which corresponds to the at least one image.

8. A method for processing ultrasound images comprising the steps of:
displaying an image sequence on a display consisting of a plurality of ultrasound images;
identifying each image of the plurality of ultrasound images by a tag of a tagging system;
receiving at least one input corresponding to at least one tag; and
bookmarking the at least one image from the plurality of ultrasound images identified by the at least one inputted tag.

9. The method according to claim 8, further comprising the step of receiving an input to freeze a real-time ultrasound image during playback prior to the displaying step, wherein the frozen image is highlighted in the displayed image sequence.

10. The method according to claim 8, further comprising the step of playing back the at least one bookmarked image.

11. The method according to claim 8, wherein the image sequence consists of a plurality of Real-time Perfusion Imaging (RTPI) ultrasound images.

12. The method according to claim 8, wherein the step of bookmarking comprises the step of writing the tag corresponding to the at least one bookmarked image within a bookmarking data structure and/or by appending the tag corresponding to the at least one bookmarked image with bookmarking information.

13. The method according to claim 8, further comprising the steps of:
displaying a list indicating the at least one bookmarked image;
receiving at least one input for displaying the at least one bookmarked image; and
displaying the at least one bookmarked image.

14. The method according to claim 8, further comprising the step of receiving at least one input corresponding to at least one tag for removing at least one image from the plurality of ultrasound images identified by the at least one inputted tag to form a modified image sequence.

15. The method according to claim 8, further comprising the step of receiving at least one input corresponding to at least one tag for trimming at least a portion of the at least one image in the plurality of ultrasound images identified by the at least one inputted tag to form a modified image sequence.

16. An ultrasound imaging system for processing ultrasound images comprising:
a display for displaying an image sequence consisting of a plurality of ultrasound images, wherein each image is assigned an identification tag of a tagging system; and
means for receiving at least one input corresponding to at least one identification tag for one of removing at least one image from the plurality of ultrasound images identified by the at least one inputted identification tag and trimming at least a portion of the at least one image in the plurality of ultrasound images identified by the at least one inputted identification tag to form a modified image sequence.

17. The system according to claim 16, further comprising means for bookmarking at least one image of the image sequence, wherein the means for bookmarking comprises means for receiving at least one input corresponding to at least one tag identifying the at least one image to be bookmarked.

18. An ultrasound imaging system for processing ultrasound images comprising:
a display for displaying an image sequence consisting of a plurality of ultrasound images, wherein each image is assigned an identification tag of a tagging system;
means for receiving at least one input corresponding to at least one tag; and
means for bookmarking the at least one image from the plurality of ultrasound images identified by the at least one inputted tag.

19. The system according to claim 18, further comprising means for playing back the at least one bookmarked image.

20. The system according to claim 18, further comprising means for receiving at least one input corresponding to at least one tag for removing at least one image from the plurality of ultrasound images identified by the at least one inputted tag to form a modified image sequence.

21. The system according to claim 18, further comprising means for receiving at least one input corresponding to at least one tag for trimming at least a portion of the at least one image in the plurality of ultrasound images identified by the at least one inputted tag to form a modified image sequence.

22. A computer-readable medium storing a series of programmable instructions for performing a method for processing ultrasound images, the method comprising the steps of:
displaying an image sequence on a display consisting of a plurality of ultrasound images;
identifying each image of the plurality of ultrasound images by a tag of a tagging system; and
receiving at least one input corresponding to at least one tag for one of removing at least one image from the plurality of ultrasound images identified by the at least one inputted tag and trimming at least a portion of the at least one image in the plurality of ultrasound images identified by the at least one inputted tag to form a modified image sequence.

23. A computer-readable medium storing a series of programmable instructions for performing a method for processing ultrasound images, the method comprising the steps of:
displaying an image sequence on a display consisting of a plurality of ultrasound images;
identifying each image of the plurality of ultrasound images by a tag of a tagging system;
receiving at least one input corresponding to at least one tag; and
bookmarking the at least one image from the plurality of ultrasound images identified by the at least one inputted tag.
